(19) United States
(12) Patent Application Publication
(10) Pub. No.: US 2008/0173464 A1
(43) Pub. Date: Jul. 24, 2008

(54) Shielded flat pair cable with integrated resonant filter compensation

(76) Inventor: Rajendran Nair, Gilbert, AZ (US)

Correspondence Address: Rajendran Nair;ComLSI Inc., 3838 E Encinas Ave, Gilbert, AZ, 85234, US

(21) Appl. No.: 11/654,168

(22) Filed: Jan. 18, 2007

(51) Int. Cl. H01B 11/02; H01B 7/00

(52) U.S. Cl. 174/117 FF

(57) ABSTRACT

A novel flat-wire-pair cable and resonant filter termination employing active interconnect principles is disclosed. The invention implements flattened conducting wires coated with insulation that are bonded to each other, providing approximately rectangular cross-sections and flat surfaces for the transport of charge through the wires. The flat wire pair may then be twisted for additional cross-talk minimization, with the twist occurring simultaneously and in identical fashion on both wires due to their attached arrangement. The terminating ends of the cable are routed on an insulating substrate forming a connector body, with the traces ending in conducting structures providing a matched resonating filter function. This filter is tuned to provide maximal benefit for the highest significant spectral content in transmitted signals. Through these enhancements, the invention interconnect architecture substantially reduces signal loss due to skin-effect and eliminates intra-pair skew. Through its active interconnect design, it amplifies high-frequency content and recovers signal energy lost due to attenuation through the length of the cable and connector termination.

### RELATED DOCUMENTS

1. Technical Field of the Invention

Embodiments of the invention relate to electronic wiring and cabling employed to conduct signals from point to point. Such embodiments fall under the category of wired interconnect components.

2. Background & Prior Art

Cables have been in use for transport of electric charge from the early days of the discovery of electricity. Cables employed for conveying electricity from generating stations to load sites are large and heavy, and therefore supported on tall poles constructed of insulating material anchored firmly to the ground. These cables came in pairs (phase, neutral) or combinations of 3 or 4 wires (3-phase with or without a neutral wire) and constituted power transmission lines. In the present day, cables are employed for various purposes including transmission of information in electric or optic form. Cables used for transmission of information in electric form usually consist of a pair of wires which together are also called a signal transmission line.

As electronic communications technology advanced, the Electronics Industry Association (EIA) and the Telecommunications Industry Association (TIA) felt the need to define performance ratings for cables. Among these specifications from the TIA/EIA are specifications for cables employed for networking computers and other associated devices called Category-5 (or Cat-5 in short) and similar standards that followed. These cables included multiple transmission lines within them, with each transmission line formed as a twisted wire pair (TWP). Cat-5 includes four such wire pairs, as does Cat-6. Twisted wire pairs are also employed effectively in other communications applications, such as the connection between peripheral devices and computing assemblies through serial communication links termed Serial-ATA (SATA).

In part due to the standardization of cables that defined them in a fashion optimal for the targeted requirement and in large part due to explosive growth in the proliferation and use of computers, these cables are very cost-effective, and have seen very little transformation or advancement in their structure and assembly architecture. Nevertheless, Cat-5e and Cat-6 cables have been proven to be effective in electronic communications at data rates of as much as 10 Gbps (10 giga-bits-per-second) over as much as 100 meters of length as currently in deployment in accordance with the 10 GBASE-T standard in the industry. Whereas these cables were originally intended to support 10 Mbps and 100 Mbps, the 100-fold effective increase in the data transfer rate for the established infrastructure based upon these cables has come about primarily due to innovation and advancement in the electronic circuits that drive and receive signals through these cables.

Contrasting with the above development for networking cables, cables in the entertainment audio and video communications industry have seen a different set of business conditions that led to numerous custom cable assemblies and exorbitant prices for such assemblies. This is in part due to insufficient interest from organizations that develop performance standards in this area, lower volumes of sale as well as the vested interests of industry cliques that develop proprietary specifications for such electronics supporting the business directions they chose. While there is a clear need for standardization for cable performance in the audio and video communications area, there is also a need, created by the promotion and consumer acceptance of proprietary specifications such as DVI and HDMI, to develop cables and cable assemblies that optimally satisfy requirements in this area of the electronics industry.

From a technology perspective, interconnect has largely been considered a passive element in any system, providing sufficient but non-ideal connectivity between different parts of the system. In that manner, a prior art twisted wire pair, whose cross-section is illustrated in FIG. 1, provides good connectivity for signals flowing in the wires, but is prone to energy loss that is proportional to the data rate, or the frequency of the transmitted signals. Energy loss in twisted wire pairs takes two principal forms, the series resistance losses due to the finite conductance of the wires as well as skin-effect, and the parallel energy losses due to the insulation dielectric that separates the two wires of a wire pair from each other. Whereas skin-effect loss (the primary series loss component) increases as the square-root of the operating frequency, dielectric losses are directly proportional to the frequency. Both contribute to substantial signal attenuation at high data rates.

Skin-effect is the tendency for electric charge flow to take the path of least impedance; at high frequencies, such a path is one where the current flow in one direction is as close as possible to that in the opposite direction, which is the charge flow configuration in a transmission line. For a prior art TWP, therefore, skin-effect forces current to flow in the darkened areas marked with the number 0 in FIG. 1. One skilled in the art will appreciate that the skin depth (the depth of the material where high-frequency currents effectively flow) is greatest where the conductors are closest to each other, and this depth reduces quickly as the conductors separate from each other as in the figure. Since conductor surfaces are very uneven, the restriction of current flow to a small volume of conducting material very close to the conductor surface leads to a very significant increase in effective series resistance in the current path, leading to substantial signal attenuation. This effect manifests both as a limited bandwidth for TWP cables as well as differentiated velocities for the varied spectral content of high-speed binary signals, leading to dispersion.

Additionally, parasitic capacitance at the end of the cables, principally in the connector structures, further attenuates the high-frequency spectral content in the signals. Capacitive reactance is inversely proportional to frequency and such attenuation therefore increases with increasing transmission frequency.

As the definition and quality of 2-D images and audio in multimedia entertainment increases, there is a need for significantly higher data rates, leading to correspondingly higher frequencies of operation of such communications links as defined in the High Definition Multimedia Interface (HDMI) specification [1]. In view of the increased signal loss in prior art cables, there is therefore a need to improve upon the twisted wire pair and the connector architecture and design.

### INVENTION SUMMARY

The invention implements flattened conducting wires coated with insulation that are bonded to each other, providing approximately rectangular cross-sections and flat surfaces for the transport of charge through the wires. The flat wire pair may then be twisted for additional cross-talk minimization, with the twist occurring simultaneously and in identical fashion on both wires due to their attached arrangement. The terminating ends of the cable are routed on an insulating substrate forming a connector body, with the traces ending in conducting structures providing a matched resonating filter function. This filter is tuned to provide maximal benefit for the highest significant spectral content in transmitted signals. Through these enhancements, the invention cable architecture substantially reduces signal loss due to skin-effect and eliminates intra-pair skew. Through its active interconnect design, it amplifies high-frequency content and recovers signal energy lost due to attenuation through the length of the cable and connector termination.

### BRIEF DESCRIPTION OF THE FIGURES

FIG. 1 illustrates a typical prior art TMDS twisted wire pair cross-section and skin-effect.

FIG. 2 is an illustration of the invention flat wire pair cross-section.

FIG. 3 is an illustration of the cross-section of a cable assembly employing flat wire pairs.

FIG. 4 is a schematic illustrating the termination of a transmission line in a resonant filter.

FIG. 5 illustrates a meandering trace pair which provides continuity for a signal transmission line while providing the characteristics of an inductor in both wires of the transmission line.

FIG. 6 illustrates a widened trace termination of a transmission line for a resonant filter function.

FIG. 7 is an illustration of terminals in a connector that may be designed to assist in a resonant filter function.

### DETAILED DESCRIPTION

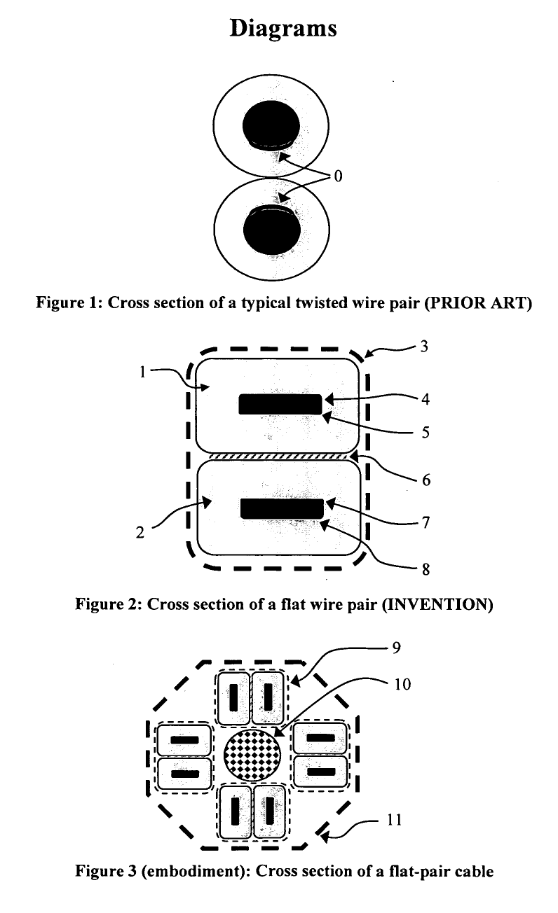

A prior art twisted wire pair (TWP) cross-section is illustrated in FIG. 1. Key aspects of the design of such a transmission line pair include a fixed separation between the central axes of the two conducting wires, the diameter of the wires and the thickness as well as dielectric permittivity of the insulation coating both wires. The electric field between the two wires passes through the insulation between the wires as well as air space adjacent to them, given the circular nature of the cross section of the wires. The dimensions of the wires, their separation and the nature of the insulating material in between provide a value of inductance and capacitance per unit length that determine the characteristic impedance of the transmission line as the square-root of the ratio of the inductance to the capacitance.

A principal aspect of TWP's is the twist introduced into the wire pair along its length. This twist entwines both wires with each other and has significant advantages for the wire pair as well as the cable assembly. Not only does the twist cancel emissions through magnetic cancellation from the wire pair, it also renders any noise introduced into the wires ‘common-mode’, or common to both wires. Additionally, by varying the rate of twist between wire pairs inside a cable assembly, noise coupled from one wire pair into an adjacent one is also diminished substantially provided the wire pairs are of sufficient length. With these important advantages, twisted wire pairs may be used in unshielded fashion; Category 5 and 6 cables as defined by the TIA/EIA standards employ both unshielded twisted pair (UTP) and shielded twisted pair (STP) architectures.

Nevertheless, prior art wire pair twist introduces a significant disadvantage in the variation of the effective lengths between the two wires of the pair. This occurs because the wires are twisted independently around each other with mechanical limitations of the machinery determining the symmetry of the twist. In the extreme example, one can imagine one of the wires twisted around the other which is held straight. While such an extreme imbalance in the twist is highly unlikely, prior art twisted wire pairs do suffer from a variance in the length of one wire with respect to the other, and this variance may accumulate over the length of the cable. A significant disparity in the effective length of one wire with respect to the other in a TWP leads to what is called ‘intra-pair-skew’ that becomes a key data rate limiting factor at high data rates. For example, an inch of difference in length between the two wires of a pair over a length of cable can lead to as much as 100 picoseconds of intra-pair skew, leading to approximately the same duration being lost in the width of the received differential signal ‘EYE’. This is because the positive pulse traveling on one line gets shifted with respect to the negative pulse traveling on the companion line, thereby reducing the duration for which these pulses appear to be opposite to each other at the receiver. Reference [4] details the negative impact of twisted pair imbalance.

Intra-pair length variance and the associated intra-pair skew are effectively eliminated in the invention wire pair architecture illustrated in FIG. 2. With reference to this figure illustrating a cross-sectional area of the invention flat wire pair, 1 and 2 are the insulating material enclosing conductors 4 and 8. 3 is a protective cover for the wire pair, 6 is a bonding layer that bonds the two insulated wires together and 5 and 7 are the skin-effect limited conduction areas in the respective conductors. The process of fabrication of wires in the invention is very similar to that of the prior art wires in the TWP's with two exceptions. An additional step is added to flatten and smooth the surfaces of the conducting metal before it is coated with insulation, and another step is added to attach the two insulated wires together on their flat surfaces. The first additional step may be accomplished by simply passing the wires through rollers spaced by the desired thickness for the flattened wires, employing any necessary thermal conditioning to minimize surface roughness on the flattened wire. The rollers employed will need to be polished to deep-sub-micron surface roughness in order to ensure that the surface roughness on the flattened metal is minimized. Once metal wires are flattened by this process, they are insulated as is done in the prior art, and the insulation material also forms roughly flat as determined by the aspect ratio of the flattened conducting metal. The flat surfaces formed on the insulated wire provide natural bonding surfaces where an adhesive appropriate to the insulating materials is applied and the two insulated wires are bonded together. Alternatively, the wires may be bonded together by simply treating the surfaces to be bonded with heat and pressure bonding them through another set of rollers. After the bond between the insulated wires is firm, preventing any movement of the wires with respect to each other, the flat wire pair is ready for insertion into its protective jacket, or may be twisted and then inserted into a protective jacket.

Because the two insulated wires are bonded together before any twist is introduced, the twist is a singular operation applied to both wires simultaneously and will be identical to both wires of the wire pair. It will hence be evident to one skilled in the art that there is negligible possibility of the twist resulting in a variance in length between the two wires of the wire pair. Intra-pair skew is therefore effectively eliminated in this flat wire pair architecture.

The second important advantage of the flat wire construction is the flat, smooth surfaces of the conducting wires. Since the separation is approximately constant at all points of the conducting surfaces facing each other in the flat wire pair, the skin depth, indicated by 5 and 7 in FIG. 2, of each conducting wire remains constant. This provides substantially greater conducting volume of sub-surface metal for high-frequency signals in the flat wire pair, diminishing the detrimental impact of skin-effect and therefore diminishing signal loss and dispersive effects. While any 2-D electromagnetic modeling and simulation tool can verify this advantage for a particular flat wire pair design relative to a prior art TWP employing approximately the same amount of conducting material, one skilled in the art can immediately appreciate this benefit upon simply observing the key differences between the prior art and the invention wire pair cross-sections.

Additionally, the flat wire pair architecture can be designed to confine most of the electric field between the two conductors to being within the insulating material. This provides a degree of homogeneity to the wire pair throughout the length of the cable and helps eliminate characteristic impedance variations caused by external aspects (neighboring wire pair) around the wire pair.

With respect to FIG. 2, the protective cover 3 may also be made conducting to provide a level of electromagnetic shielding from neighboring flat wire pairs as well as to provide a reference plane for the two conductors that assists in further increasing the skin-depth limited conduction area in the cross-section by the use of the two non-adjacent flat surfaces of the wires 4 and 8.

FIG. 3 illustrates an embodiment cable architecture employing flat wire pairs within a cable assembly. With reference to this figure, 9 is a flat wire pair, 10 is a cable core that may provide mechanical strength, physical separation between the flat wire pairs and may also provide signal and/or power conduction pathways. 11 is the cable outer jacket that maintains the cable form and may also be made conductive to provide additional shielding as well as a power return pathway.

Notwithstanding the advantages discussed so far, all transmission lines attenuate signals, with this attenuation increasing with frequency and length. Energy loss mechanisms include skin-effect resistance increases as discussed and dielectric energy losses. Skin-effect losses are proportional to the square root of the operating frequency, while dielectric losses are proportional to the frequency. At data transfer frequencies of multiple gigahertz, these losses on simple TWP based cables can be as high as 1 dB/m, leading to as much as an order of magnitude attenuation in signals over 20 meters of cable. This is particularly true for binary signaling, employing a symbol set limited to 2, which is considered fully ‘digital’ and therefore extremely robust, because binary symbols are separated from each other in time by voltage transition edges that correspond to extremely high-frequency energy. These inescapable losses in lengths of cable attenuate the highest frequency spectral components of the transmitted signals disproportionately, leading to loss of signal integrity and differential ‘EYE’ closure. Aspects of signal loss in cable assemblies similar to category 5 are discussed in some detail in reference [2].

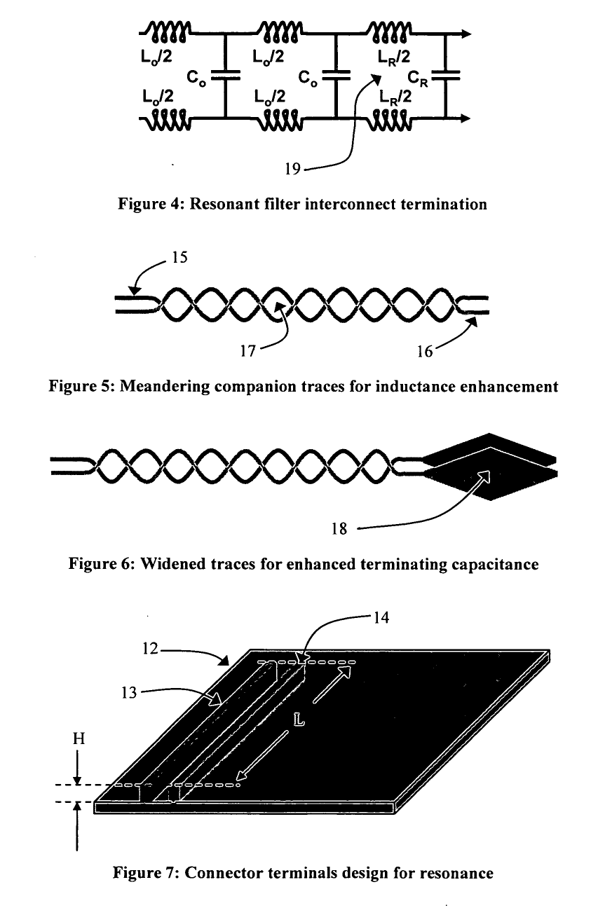

In order to compensate for this attenuation of the highest significant spectral content of signal energy, the invention interconnect architecture introduces concepts of Active Interconnect, where sections of the interconnect form electronic circuits that assist in amplifying the diminished high-frequency energy. This concept is illustrated in FIG. 4 that shows a typical transmission line terminating in components that form a resonant tank circuit. Lₒ and Cₒ are the unit inductance and capacitance of the transmission line with the characteristic impedance given by the square root of Lₒ/Cₒ. The terminating components have inductances of L_{R} and C_{R}, which form a tuned circuit with a resonant frequency corresponding to 1/(2·π·SQRT(L_{R}·C_{R})).

Reference [3] investigates and indicates the benefit of resonant filters employed to recover high frequency (or edge-related) signal energy. A circuit tuned to resonate at a particular frequency value reinforces spectral constituents in stimulating signals of the same frequency, thereby amplifying those constituents. Although simulations indicate that the use of discrete inductors and capacitors could result in amplification of spectral components close to the resonance frequency of the filter, it is important to ensure that the components of the resonant filter are realized in a manner that does not break the continuity of the signal flow pathways.

Given that a resonant filter is realized by the combination of inductors and capacitors, the invention interconnect architecture implements inductors as illustrated in FIG. 5. With reference to this figure illustrating a ‘meandering trace pair’ of the transmission line, 15 and 16 are the two traces of the transmission line, and 17 illustrates a ‘meandering’ section. Traces 15 and 16 are fabricated facing each other on an insulating substrate and are separated by a thickness of a layer in a manner so as to accomplish the same characteristic impedance as that of the flat wire pair in the cable. This fabrication of traces is common in the art that employs organic substrates and insulating material with conductive traces. The traces are then ‘meandered’ with respect to each other as indicated in FIG. 5. In other words, they do not follow the same linear path as normal traces do, and crisscross each other as viewed from above. This results not only in a substantial reduction in the capacitance between the traces, but also minimizes magnetic cancellation between the traces, or in other words, greatly increases the magnetic loop area. The inductance per unit length therefore multiplies in accordance with the increase in the magnetic loop area, and because of the greatly reduced capacitance as well, the traces behave as if they are inductors for the meandered section. Nevertheless, continuity is maintained for the forward and return currents of signals within the traces without the introduction of other unwanted parasitic elements. In one embodiment, meandering is implemented with trace segments being approximately orthogonal with each other, or the meander angle is 90 degrees. The meandering distance (or width) may be constrained at its upper limit by practical connector design considerations and at its lower limit by the trace width itself.

FIG. 6 illustrates the transformation of the traces presenting characteristic impedance into inductors and further into a largely capacitive section in the region marked 18. In this region, the traces are widened very substantially while fully overlapping each other as is the case with typical transmission line trace pairs. This section therefore sees full and enhanced magnetic cancellation, while the capacitance, proportional to the overlap area is multiplied by a factor corresponding with the average increase in trace width. Therefore inductance per unit length in the section of the traces marked 18 is reduced, and the traces together behave as a capacitor in this region, while maintaining signal flow continuity as well. The combination of meandering and trace-widening can be designed to emulate a resonant tank circuit, providing resonant gain for specific spectral components in the signals received. Nevertheless, skin-effect resistances and unintended parasitic capacitances due to the widened trace areas with respect to the connector body etc. may diminish the gain of such resonant structures.

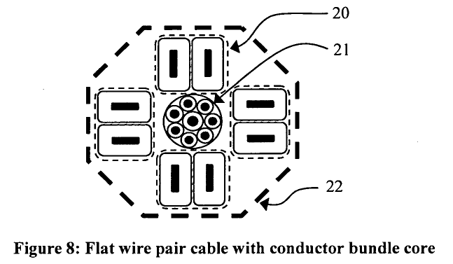

FIG. 7 illustrates an alternate embodiment of active interconnect resonant structure employing fabricated connector terminals placed close to each other. With reference to this figure, 12 is the insulating substrate, 13 and 14 are sections of connector terminals for a trace pair and H and L are dimensions of the connector terminal pair section employed as a resonant structure. By designing the separation between the connector terminals and dimensions H and L, one may appreciate feasibility of low-loss resonant waveguides for frequencies of a few gigahertz and beyond.

Although specific embodiments are illustrated and described herein, any device arrangement configured to achieve the same purposes and advantages may be substituted in place of the specific embodiments disclosed. This disclosure is intended to cover any and all adaptations or variations of the embodiments of the invention provided herein. All the descriptions provided in the specification have been made in an illustrative sense and should in no manner be interpreted in any restrictive sense. The scope, of various embodiments of the invention whether described or not, includes any other applications in which the structures, concepts and methods of the invention may be applied. The scope of the various embodiments of the invention should therefore be determined with reference to the appended claims, along with the full range of equivalents to which such claims are entitled. Similarly, the abstract of this disclosure, provided in compliance with 37 CFR §1.72(b), is submitted with the understanding that it will not be interpreted to be limiting the scope or meaning of the claims made herein. While various concepts and methods of the invention are grouped together into a single ‘best-mode’ implementation in the detailed description, it should be appreciated that inventive subject matter lies in less than all features of any disclosed embodiment, and as the claims incorporated herein indicate, each claim is to viewed as standing on its own as a preferred embodiment of the invention.

What is claimed is:

1. A wire pair for electrical signal transmission, comprising
a first flattened wire with substantially rectangular conductor of width to thickness aspect ratio less than or equal to 10, with at least one smooth, flat conductor surface and conforming insulating cover with flat parallel surfaces:
a second flattened wire identical to the first flattened wire in electrical and physical aspects:
where the first and second wires are bonded immovably together such that the parallel flat smooth conductor surfaces of the first wire and the second wire face each other.

2. The wire pair of claim 1, with the flat surfaces of the conductors treated thermally or chemically to reduce surface roughness.

3. The wire pair of claim 1 with a highly conductive protective cover employed as a shield.

4. The wire pair of claim 1, twisted along its length to minimize differential coupling with adjacent conductors as well as to minimize electromagnetic emissions.

5. The wire pair of claim 1, where the insulating cover has a relative dielectric permittivity that is dependent upon, or varies with, transmitted signal frequency.

6. The wire pair of claim 1 where the conductor is made of copper or silver-plated copper.

7. A cable comprising of a plurality of wire pairs of claim 1, with a core separating the wire pairs from each other.

8. The cable of claim 7, where the core comprises of insulated conducting wire or wires for low-frequency signal and direct current power transmission.

9. The cable of claim 7, with a highly conductive protective outer cover employed as a shield or as a direct current power conduction pathway.

10. (canceled)

11. (canceled)

12. (canceled)

13. A method for minimizing intra-pair skew in a wire pair, comprising:
Providing insulated conducting wires, each with a substantially rectangular smooth conductor of width to thickness aspect ratio less than or equal to 10 and conformal insulation covering with flat surfaces;
attaching immovably two such flat wires at their flat surfaces to form a wire pair with a bonded region.

14. The method of claim 13 where the wires of the wire pair are attached to each other with an adhesive material.

15. The method of claim 13, where the wires of the wire pair are attached to each other through a thermal cohesive bond.

16. The method of claim 13, where a width of the bonded region between the two flat wires is greater than a width of the flat conductors embedded within the wires.

17. Electronic systems transmitting data through binary signaling at 1 billion bits per second and beyond that employ the wire pair of claim 1.

18. (canceled)

19. Electronic cables and systems for signal transmission at high data rates that employ the method of claim 13.
